(19) United States
(12) Patent Application Publication
(10) Pub. No.: US 2009/0078785 A1
(43) Pub. Date: Mar. 26, 2009

(54) METHOD AND DEVICE FOR ATOMIZING A LIQUID

(75) Inventor: Stephan Herminghaus, Goettingen (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Max-Planck-Gesellschaft zur Foerderung der Wissens chaften e.V., Muenchen (DE)

(21) Appl. No.: 12/293,111

(22) PCT Filed: Mar. 14, 2007
(86) PCT No.: PCT/EP2007/002256

§ 371 Date: Sep. 22, 2008

(30) Foreign Application Priority Data
Mar. 17, 2006 (DE) 10 2006 012 389.1

(51) Int. Cl. B05B 1/34; B05B 17/04

(52) U.S. Cl. 239/11; 239/461; 239/474; 239/487

(57) ABSTRACT

A method for atomizing at least one liquid (1) using an atomizer (10) which has at least one annular gap (11) is described, with the following steps: letting out the liquid (1) through the at least one annular gap (11) into an atomizer chamber (20), wherein at least one constriction of the annular gap (11) is produced, the constriction running around the at least one annular gap (11), and disintegrating the liquid (1) in the atomizer chamber (20) into liquid droplets (2) at a distance from the at least one annular gap (11). An atomizer (10) for carrying out the method is also described.

The invention relates to a method for atomizing a liquid, in which a liquid flow disintegrates in an atomizer device device chamber into liquid droplets, and to an atomizer device for liquids for carrying out the method.

The atomizing of liquid is of interest in many technical processes, e.g., in the chemical engineering, in the medicine technology, in the coating technology and in the operation of internal combustion engines or also of snow guns. In the practice, different types of atomizer devices are known that differ as regards the type of the formation of the liquid jet during leaving out of the atomizer device, the homogeneity and the rate of the atomizing. For example, an individual jet nozzle such as in a medicinal or cosmetic spray dispenser, a nozzle array as in an ink jet printer or in an atomizer device in accordance with U.S. Pat. No. 5,248,087, or an annular gap as in a microvalve in accordance with EP 778 927 can be provided.

The conventional atomizing techniques have the general disadvantage that they are designed either for a homogeneous, narrow size distribution of the liquid droplets or for a high liquid throughput. For example, there are high requirements in a conventional ink jet printer as regards the homogeneity of the droplet size, but the amount of droplets produced per time unit is limited. On the other hand, large amounts of liquid can be atomized with a paint spray of a paint plant in which there are lower requirements on the homogeneity of the droplet size.

However, no atomizer devices are known with which the requirements for the atomization rate and the homogeneity of the droplets can be fulfilled in the same manner. Thus, in internal combustion engines large amounts of liquid must be atomized. For example, in the gas turbine of an airplane the fuel must be introduced at an atomization rate of e.g., 100 ml/s as a fine mist into the combustion chamber of the gas turbine. On the other hand, it is important for a high degree of efficiency in the combustion process and for the lowest possible outlet of harmful substances that the liquid droplets have the most uniform size possible. There are similar problems in the operation of high-performance inkjet printers or when using droplet emulsions in the chemical engineering, e.g., for the synthesis of nanoparticles.

The invention has the objective of providing improved methods and devices with which the disadvantages of the conventional techniques are overcome and that in particular make it possible to generate liquid droplets with an elevated atomization rate with improved homogeneity of the droplet size at the same time.

This objective is solved with an atomization method or an atomizer device with the features of Claims 1 or 12. Advantageous embodiments and applications result from the dependent claims

As concerns the method, the invention is based on the general technical teaching of pressing at least one liquid through at least one annular gap in which at least one constriction that runs repeatedly around it is produced. The liquid being discharged at the annular gap into a free atomizer device chamber forms a tubular liquid layer (lamella) that disintegrates into liquid droplets in the atomizer device chamber at a distance from the annular gap. The disintegration takes place without the liquid contacting a solid surface in the atomizer device chamber. The disintegration into liquid droplets is formed with a predetermined pattern in distinction to conventional atomizer devices with an annular gap by the constriction circulating around the annular gap. A spiral-shaped (helical) instability area is impressed on the liquid layer by the circulating constriction, on which area a cutting off of the liquid layer takes place in the atomizer device chamber so that a spiral liquid jet (liquid strand) is formed. The spiral liquid jet then disintegrates based on the so-called Rayleigh instability into individual liquid droplets.

As regards the device, the above-cited objective is solved in a corresponding manner by an atomizer device for the disintegration of a liquid, that comprises at least one annular gap and one drive device for producing the at least one constriction circulating along the annular gap.

A significant advantage of the invention consists in the combination of the discharging of the liquid from the annular gap with the destabilization of the liquid layer being discharged through the constriction running along the annular gap. The use of the annular gap makes possible a liquid throughput that is elevated in distinction to the conventional nozzle array and therefore makes an elevated atomization rate possible. The destabilization of the liquid layer by the circumferential constriction results in the Rayleigh disintegration of the spiral liquid jet into droplets of the same size, which was achieved prior to the invention only with straight, linear liquid jets.

The producing of a constriction running along the annular gap means that the radial width of the annular gap is subjected in a locally limited manner to a repeated, preferably periodic variation that is described as an oscillation with a predetermined amplitude and phase constantly running along in the gap. The constriction does not occur in all spatial directions at the same time but rather with the phase shift in successively different radial directions. The constriction of the annular gap forms a wave ciculating azimuthally.

The at least one annular gap has an axial reference direction that coincides with the direction of flow of the liquid, a radial reference direction standing vertically on the axial reference direction, and an azimuthal reference direction that describes the curved course of the annular gap.

According to the invention several (at least two) circumferential constrictions with circumferential speeds that are the same or different relative to each other can be produced in one or more annular gaps. In the case of the same circumferential speeds several spiral instability areas offset relative to each other are produced. Two circumferential constrictions can advantageously be produced by the excitation of self-oscillations, e.g., of an inner part limiting the annular gap, such as a cylindrical pin. Several circumferential constrictions can moreover be produced by an adapted excitation of the parts limiting the annular gap with at least one oscillation source.

There are advantageously different possibilities for generating the circumferential constriction, thus, e.g., with a circumferential projection provided on one of the parts limiting the annular gap. However, according to a preferred embodiment of the invention the circumferential constriction is formed by a gap oscillation generated on at least one of the structural parts limiting the at least one annular gap. To this end at least two annular gap parts arranged concentrically to each other are provided and one annular gap is limited by two annular gap parts. The gap oscillation is excited on at least one of the annular gap parts that are adjacent in the concentric arrangement in order to generate the at least one circumferential constriction. The concentric arrangement of the annular gap parts means that the inner and outer surfaces of the bordering annular gap parts, which surfaces form an annular gap, have a common point of symmetry in the state of rest, that is, without excitation of the gap oscillation. In particular, a coaxial alignment relative to the direction of the liquid flow during the discharging from the annular gap is provided. The use of several concentrically arranged annular gaps advantageously makes possible an elevated liquid throughput and therewith an elevated atomizer device rate.

If, according to a first variant, one single annular gap is provided and the circumferential constriction is produced by a gap oscillation of at least one of the adjacent annular gap parts, advantages result for a compact construction of the atomizer device. The atomizer device comprises in this instance two annular gap parts. The outside diameter of the first (inner) annular gap part is smaller than the inside diameter of the second (outer) annular gap part, so that the annular gap is formed between both annular gap parts. At least one of the annular gap parts can be loaded with a mechanical oscillation in such a manner that the desired constriction runs around. To this end the drive device of the atomizer device preferably comprises an oscillation source with which the gap oscillation of the inner and/or an outer annular gap part can be excited.

If the gap oscillation is generated according to a preferred design with the inner annular gap part while the outer annular gap part is stationarily fixed, advantages result from a simplified construction of the atomizer device and the relatively low mass of the moved inner annular gap part. According to an alternative design the oscillation of the outer annular gap part relative to an inner annular gap part present in the fixed state or an oscillation of both parts can be provided.

Advantages for a compact structural form of the atomizer device and a uniform supply of the liquid to the annular gap result in particular if the outer annular gap part is stationarily formed in the atomizer device with a conduit in which the inner annular gap part is arranged. The conduit and the inner annular gap part preferably have the form of straight circular cylinders. The inner annular gap part is concentrically arranged in the conduit. In this case the inner annular gap part is preferably a longitudinally extended, cylindrical structural part with a free end that forms the annular gap with the outer ring part, and with a fixed end permanently connected to the atomizer device. The inner annular gap part is preferably a cylindrical pin that is fixed on one side and is formed to be compact or hollow. The self-oscillation of the pin advantageously has two maxima per revolution so that two circumferential constrictions can be produced in an especially simple manner.

If, according to a second variant, two annular gaps are provided that are limited on the one hand by the first and second annular gap parts and on the other hand by the second annular gap part and a third annular gap part that surrounds the second annular gap part, circumferential constrictions can be advantageously produced by the gap oscillation exclusively of the second annular gap part in the first and in the second annular gap.

With several annular gaps different liquids can be advantageously atomized at the same time. In this case special advantages result when used in the chemical engineering.

The oscillation source of the atomizer device preferably comprises an electromagnetic drive such as, e.g., an electromagnetic apparatus that acts on a magnetic material in the particular driven annular gap part, e.g., in the first annular gap part. If two partial oscillations are generated with the electromagnetic apparatus that stand vertically relative to one another and relative to the axial direction of the annular gap and have a slight phase difference, preferably a phase difference of one fourth of an oscillation, their superpositioning results in a magnetic drive force with azimuthally circumferential direction. The annular gap is constricted in accordance with the current alignment of the drive force.

It can be advantageously provided in accordance with the invention that at least one parameter of the gap oscillation, in particular the rotational frequency and/or the amplitude of the gap oscillation, can be purposefully adjusted in such a manner that the liquid droplets are formed with a predetermined size. To this end the oscillation source of the atomizer device is preferably adjusted for a variable setting of the frequencies and a mutual phase shift of the partial oscillations. The setting of at least one parameter of the gap oscillation has the particular advantage that in addition to the flow rate of the liquid a further degree of freedom for the setting of the drop size is created. In this manner the area of application of the atomizer device can be expanded and the dependency on viscosity properties of the liquid reduced.

The generation of the constriction running along the annular gap with at least one gap oscillation thus permits large amounts of at least one liquid, e.g., of a fuel or of an active substance to be atomized into small droplets of uniform size. The liquid(s) to be distributed is/are pressed through the annular gap, whose one boundary is fixed and whose other boundary is formed by a structural part, e.g., the inner annular gap part, moving with a high frequency in the ultrasonic range. The mechanical oscillation of the inner annular gap part is coupled into the liquid in the annular gap so that the spiral-shaped dynamic instability of the liquid layer is formed that is discharged out of the annular gap.

The rotational frequency of the constriction, that is, the rotational frequency of the gap oscillation, is preferably selected to be above 10 kHz, e.g., in the range of 10 kHz to 400 kHz, especially preferably in the range of 20 kHz to 200 kHz. In this frequency range droplets from liquids with typical inflow rates can be advantageously formed such as those required, e.g., in internal combustion engines.

According to a further advantageous feature of the invention the Rayleigh disintegration of the spiral-shaped liquid jet can be furthered if an azimuthal structure is impressed on at least one liquid surface of the liquid layer being let out through the annular gap. The spatial frequency of the azimuthal structure is selected in accordance with the size of the individual droplets formed by the Rayleigh disintegration. The atomizer device in accordance with the invention accordingly comprises an outer or inner surface structure on at least one of the annular gap parts. The surface structure of the at least one annular gap part in addition to the spiral-shaped instability generates an instability furthering the disintegration of the spiral-shaped liquid jet into individual droplets.

A further important advantage of the invention consists in the expanded usability with different substance systems. The liquid being discharged through the annular gap can generally be atomized into an environment of another fluid, especially of a gas or of a further liquid or into an environment of reduced pressure, especially into a vacuum chamber. A gaseous environment, a liquid environment or a vacuum is formed in the atomizer device chamber directly adjacent to the annular gap.

The liquid being discharged out of the annular gap into the atomizer device chamber is preferably loaded with a predetermined working pressure. The rate of the liquid and as a result the droplet size after the atomization can be advantageously adjusted with the working pressure.

There are advantageously no limitations relative to the amplitude of the annular gap constriction in the practical realization of the invention. It is advantageously sufficient for the liquid atomization in accordance with the invention if the constriction of the annular gap is at least 1%, preferably at least 10% of the width of the annular gap. Such a slight limitation of the annular gap width already results in the desired spiral-shaped instability. Alternatively, a greater constriction of the annular gap down to the annular gap width of zero can be provided.

A further advantage of the invention consist in the broad area of application of the atomizer device, e.g., for the supply of fuel or reactant for the forming of active substance aerosols or for the generation of artificial snow crystals.

Further details and advantages of the invention are described in the following with reference made to the attached drawings.

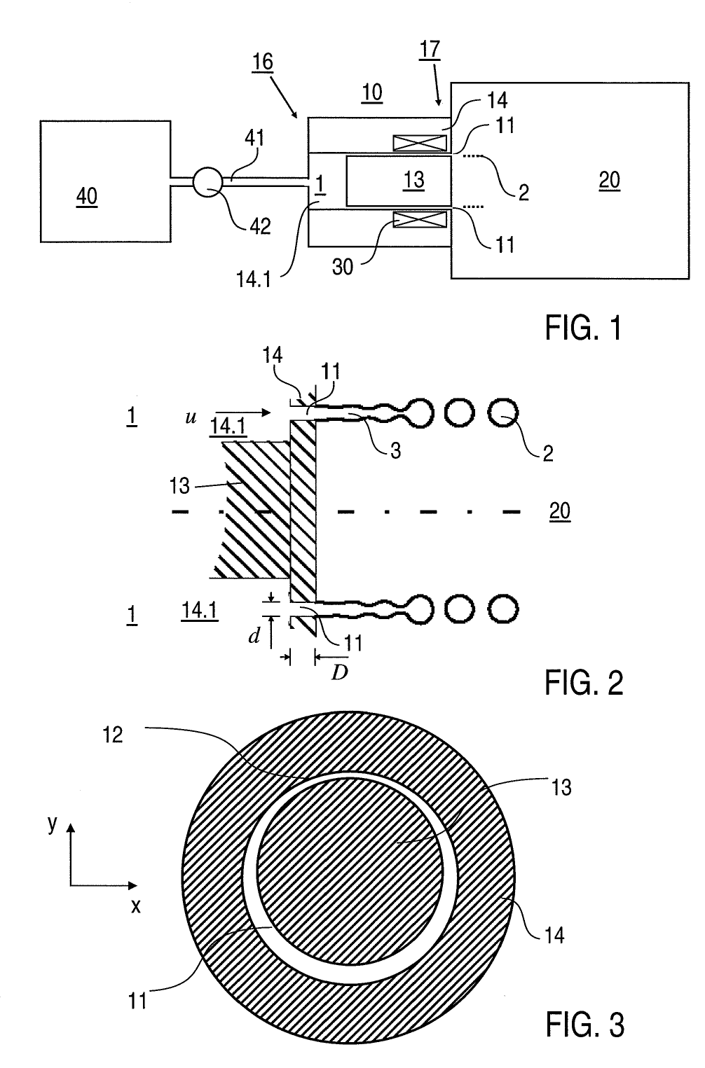

FIG. 1 shows a schematic view of an atomizer device in accordance with the invention;

FIG. 2 shows a sectional view of the annular gap used in accordance with the invention according to a first embodiment of the invention;

FIG. 3 shows a top view onto the annular gap atomizing FIG. 2;

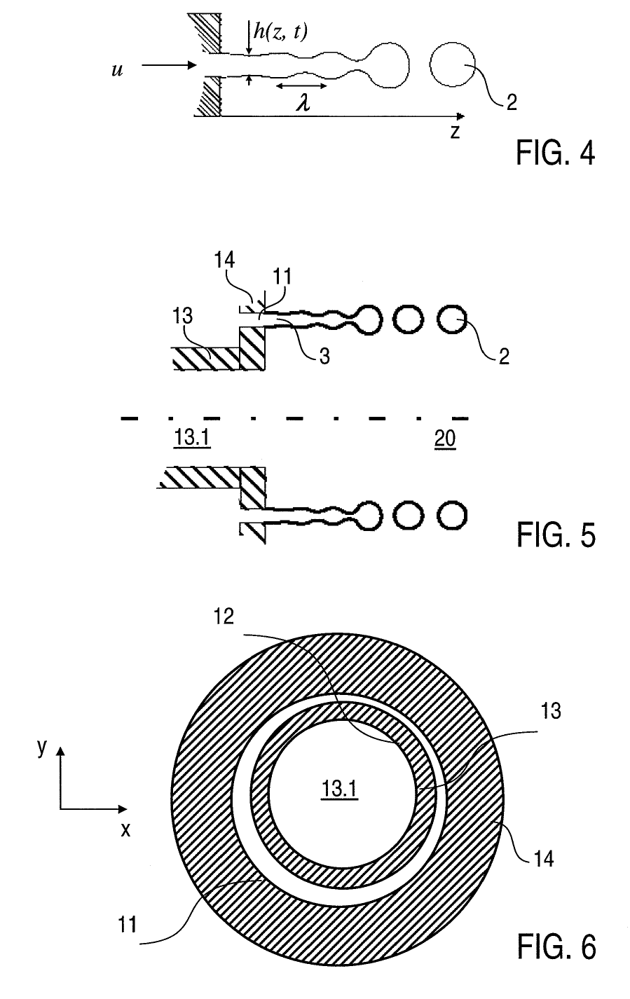

FIG. 4 shows a schematic illustration of the droplet formation in accordance with the invention;

FIG. 5 shows a sectional view of the annular gap used in accordance with the invention and according to a second embodiment of the invention;

FIG. 6 shows a top view of the annular gap in accordance with FIG. 5;

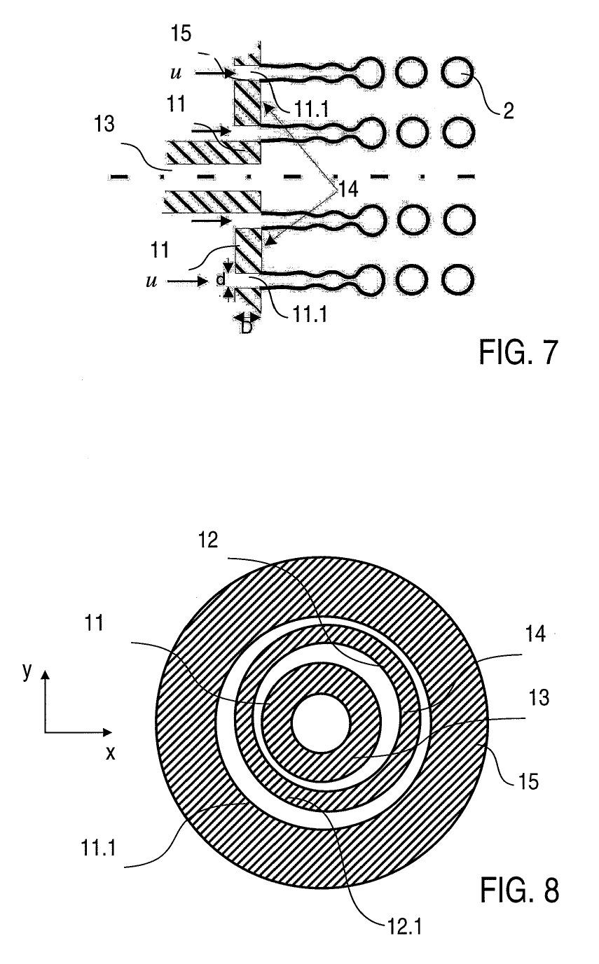

FIG. 7 shows a sectional view of annular gaps used in accordance with the invention according to a third embodiment of the invention,

FIG. 8 shows a top view of the annular gap according to FIG. 7, and

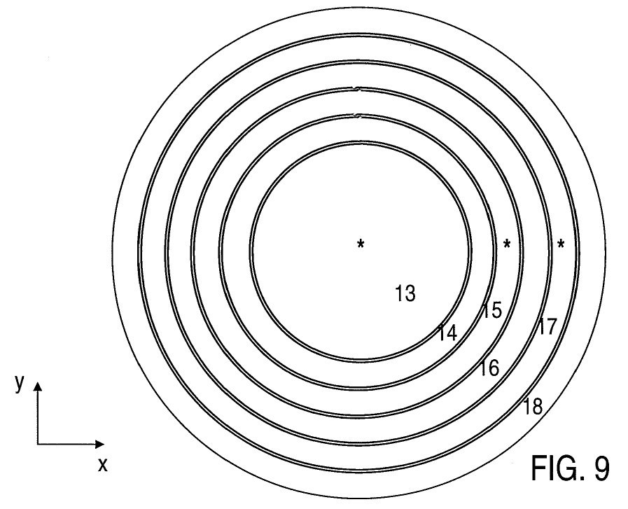

FIG. 9 shows a top view of a plurality of annular gaps used in accordance with the invention according to a further embodiment of the invention.

The atomization of a liquid in accordance with the invention is described in the following with reference made by way of example to a schematically represented atomizer device. It is emphasized that the structural form of the atomizer device and in particular of the annular gap parts for forming the annular gap can be realized in modified form as a function of the concrete use of the invention. For example, instead of a circular annular gap an annular gap with another curved form, e.g., an elliptical form, or with a polygonal form can be provided. In the case of an annular gap with a polygonal form a preferably regular polygon with, e.g., 4 or more corners is formed from straight gap sections. However, a more complex gap form can be provided in which an inner edge forms, e.g., a circle or an ellipse and the outer edge forms a polygon.

For the atomization of a liquid 1 in accordance with the invention into a plurality of individual liquid droplets 2 the liquid 1 is pressed with an atomizer device 10 according to FIG. 1 through an annular gap 11. The annular gap 11 is formed between the first, inner annular gap part 13 and the second, outer annular gap part 14. To this end the outer annular gap part 14 comprises a conduit 14.1 with, e.g., circular cross section in which the inner annular gap part 13 is concentrically arranged with its free end facing the annular gap 11 capable of oscillation. The opposite end of the inner annular gap part 13 is fixed in the conduit 14.1 in a suitable manner, for example, with webs on the outer annular gap part 14 so that the liquid 1 can enter into annular gap 11. The inner annular gap part 13 can have the form of a massive pin (see FIGS. 2, 3, 9) or the form of a hollow cylinder (FIGS. 5, 6, 7, 8).

The atomizer device 10 comprises a supply side 16 at which the liquid 1 flows into the conduit 14.1. The side in which the liquid is let out of the annular gap 11, disintegrates into the liquid droplets 2, and which is opposite the supply side 16, is designated as outlet side 17.

The outer annular gap part 14 contains the drive apparatus, which comprises, e.g., an oscillation source 30 for the electromagnetic drive of the inner annular gap part 13. The annular gap part whereon the gap oscillation should be excited, consists, e.g., completely or partially of a magnetic material whereon a magnetic force can be exerted with the oscillation source 30. The annular gap part, that should remain stationary, generally consists of a non-magnetic material, e.g., aluminum or plastic, so that no magnetic force can be exerted with the oscillation source 30.

The annular gap 11 empties on the outlet side 17 directly into the atomizer chamber 20. The outlet end of the annular gap 11 opens directly into the atomizer chamber 20. The flow path of the liquid 1 from the annular gap 11 into the atomizer chamber 20 is free of mechanical components. The atomizer chamber 20 is formed as a function of the concrete task of the atomizer device 10 and comprises, e.g., a combustion chamber of an internal combustion engine, a reactor for chemical reactions or a free atmospheric environment.

A liquid reservoir 40 is connected via a supply line 41 and a pump apparatus 42 to the supply side of atomizer device 10. The liquid 1 is pressed with the pump apparatus 42 into the annular gap 11. The pressure in the conduit 14.1 is, e.g., 20 to 30 bar.

Further details of the atomizer device 10 with an inner annular gap part in the form of a compact cylindrical pin 13 are illustrated in the FIGS. 2 and 3. The liquid 1 to be dispersed is pressed in FIG. 2 coming from the left under pressure at a rate u through the annular gap 11. The annular gap 11 has a gap width d, that is typically less than 1 mm, e.g., 100 μm and is essential for the size of the liquid droplets 2 formed in accordance with the invention. The liquid being let out at annular gap 11 into the free atomizer device chamber 20 forms a tubular liquid layer 3.

If the inner annular gap part 13, whose outer edge forms the inner edge of the annular gap 11, is put in a circular oscillation, the annular gap 11 is therefore periodically constricted and therefore periodically modulates the rate at the gap outlet into the atomizer device chamber 20. As a result of the circular oscillation a radial constriction 12 (see FIG. 3) of the annular gap 11 is formed that runs along the annular gap 11 in an azimuthal manner.

The circular oscillation is generated, e.g., with the oscillation source 30 (see FIG. 1) in which two magnetic field components standing vertically to each other in the x and 7 direction are generated with a slight phase shift so that the resulting magnetic field component runs around in the x-y plane and the circumferential constriction 12 is correspondingly formed. The frequency of the running along of constriction 12 is, e.g., 30 kHz. If several constrictions running along in opposite directions are produced in the annular gaps the rotational frequency can advantageously be elevated by the factor 2.

The liquid layer 3, which is tubular at first, disintegrates into individual droplets 2 on the basis of the following estimation. The movement of the center point of the inner annular gap part 13 can be described with:

y(t)=a sin(2πv·t) and x(t)=a cos(2πv·t). (1)

(v: Frequency of the rotation of the constriction 12, a: Amplitude, t: Time).

Accordingly, the constriction 12 of the annular gap 11 occurs everywhere with the same period but with shifted phase. The liquid rate u is modulated in time in accordance with equation (2) at the outlet of annular gap 11 into the atomizer device chamber 20:

u(t)≈u₀+u₁ sin(2πvt+ψ) (2)

(in which ψ is a phase varying linearly with the azimuth angle φ).

In a corresponding manner the thickness h of the liquid layer 3 being let out of the annular gap 11 varies in space and time, as is schematically illustrated in FIG. 4. The wavelength λ of this variation is directly given by the average exiting rate u₀ and the frequency ν of the pin oscillation:

λ=u₀/v (3)

The mass moment of inertia of the liquid 1 has the result that the rate modulation according to equation (2) is continued into the liquid layer 3. The rate u(z,t) in the jet is described by the so-called Burgers equation according to equation (4):

$$\frac{δ u}{δ t} + \frac{δ u}{δ z} = \frac{γ}{ρ} \frac{{δ}^{2} h}{δ {z}^{2}} \qquad ( 4 )$$

In equation (4) γ signifies the surface tension (and/or the boundary surface tension during the emulsification) and ρ the density of the liquid 1. Based on the Burgers equation (4) the constriction of the liquid layer 3 occurs according to a characteristic pathlength z₀. The pathlength z₀ can be approximately described according to equation (5) with:

$${z}_{0} = \frac{λ {u}_{0}}{2 π {u}_{1}} \qquad ( 5 )$$

Accordingly, an approximately cylindrical bead forms in the liquid layer 3 with the distance z₀ from the end of the annular gap 11, the cross-sectional area of which bead is given by λd.

On account of the constriction 12, running around in the course of time (see FIG. 3), of the annular gap 11 a torus is not formed by the constriction but rather a spiral strand with a characteristic rise λ. The constriction process takes place in a continuously circulating manner at a location after the end of the annular gap 11. As a result, the production of satellite droplets with sharply deviating and therefore undesired size is minimized or excluded.

The cylindrical bead disintegrates subsequently by the Rayleigh plateau instability into individual droplets 2. The distance of the droplets according to equation (6) is given here by

Λ=π\sqrt{8r}=\sqrt{8πdλ}. (6)

(r: Radius of the circularly approximated strand cross section).

Accordingly, the liquid droplets 2 have a volume of approximately

\sqrt{8πd³λ³} (7)

And correspondingly a radius of approximately

R≈1.28\sqrt{πdλ} (8).

The disintegration of the spiral liquid jet can be furthered by an azimuthal surface structure. The azimuthal surface structure comprises a corrugation that exactly comprises the period of the Rayleigh plateau instability according to equation (6). A deformation field is formed by the surface structure in the annular gap 11 on the cylindrical bead being produced by the first constriction which field corresponds to the maximally unstable wave number and thus results within a few microseconds in the constriction.

The oscillation amplitude a according to equation (1) is selected on the basis of the following considerations. The first constriction for the formation of the spiral liquid jet takes place at a distance from the end of the annular gap 11 that is less than a wavelength λ (z₀≦λ). The relation according to equation (9) applies for the rate modulation v₁ on account of the retention of mass under the assumption of a slight compressibility.

u₁d=πvaD (9)

so that equation (4) yields:

$$a \geq \frac{λ d}{2 {π}^{2} D} \qquad ( 10 )$$

In the equations (9) and (10) D is the axial length of the annular gap 11 (see FIG. 2).

If D≧λ is satisfied, the condition according to equation (10) can always be readily satisfied. For an especially homogeneous droplet formation after the annular gap 11 the amplitude a according to equation (11) is selected as follows.

$$\frac{a}{d} \geq \frac{2 d}{π D} \qquad ( 11 )$$

Given gap widths d of, e.g., 100 μm and a viscosity of the liquid 1 corresponding to the viscosity of water at room temperature, an axial length D of the annular gap 11 of around 1 mm is selected.

For the dispensable massive throughput dV/dt the following applies with the gap length L according to equation (12):

$$\frac{d V}{d t} = {u}_{0} d L . \qquad ( 12 )$$

If a metal pin (L=3 cm) with a resonance frequency of 40 kHz is used as inner annular gap part 13, then 180 ml liquid can be atomized at an outlet rate of 60 m/s. For this, energy of only a few watts (typically less than 1 W) is advantageously required, and the damping of the oscillation of the inner annular gap part 13 by the liquid present in the annular gap 11 can be disregarded.

FIGS. 5 to 9 illustrate modified embodiments of the invention. In the embodiment shown in FIGS. 5 and 6 the inner annular gap part 13 comprises a hollow cylinder with an inner hollow chamber 13.1. The annular gap 11 is formed between the inner annular gap part 13 and outer annular gap part 14. In the embodiment shown in FIGS. 7 and 8 several concentric annular parts 13, 14 and 15 are provided that form two annular gaps 11, 11.1 with two constrictions 12, 12.1. The above estimations apply in a corresponding manner for each of the annular gaps. The annular gaps 11, 11.1 can be connected to a common conduit 14.1 (see FIG. 1) or to separate conduits for the supplying of different liquids.

The principle of the concentrically formed annular gaps can be expanded, as is shown by way of example in FIG. 9 with the top view onto the outlet end of an atomizer device in accordance with the invention. Six annular parts 13 to 18 are provided between which an annular gap is formed. Each second annular gap part is loaded with the gap oscillation (see symbol *), so that the circumferential constrictions can be produced in the bordering annular gaps.

The features of the invention disclosed in the previous description, the drawings and the claims can be of significance individually as well as in combination for the realization of the invention in its various embodiments.

1. A method for atomizing at least one liquid with an atomizer device comprising at least one annular gap, said method comprising the steps:
discharging the liquid through the at least one annular gap into an atomizer device chamber, in which at least one constriction of the annular gap is produced that runs along the at least one annular gap and
disintegrating the liquid into liquid droplets in the atomizer device chamber at a distance from the at least one annular gap.

2. The method according to claim 1, in which a concentric arrangement of at least two annular gap parts and the at least one annular gap is formed between annular gap parts that are adjacent in the concentric arrangement, wherein the at least one circumferential constriction is produced by a gap oscillation of at least one of the annular gap parts that limit the corresponding annular gap.

3. The method according to claim 1, in which a first annular gap is provided that is limited by a first and a second annular gap part, wherein the circumferential constriction is produced by a gap oscillation of at least one of the first and second annular gap parts.

4. The method according to claim 3, in which a second annular gap is provided that is limited by the second annular gap part and a third annular gap part that surrounds the second annular gap part, wherein circumferential constrictions, are produced by the gap oscillation of the second annular gap part in the first and second annular gap.

5. The method according to claim 2, wherein at least one oscillation parameter of the gap oscillation is adjusted in such a manner that the liquid droplets have a predetermined size.

6. The method according to claim 2, wherein a rotational frequency of the gap oscillation is selected in the range of 10 kHz to 400 kHz.

7. The method according to claim 1, further comprising the step of impressing of an azimuthal structure on at least one liquid surface of the liquid being let out through the at least one annular gap.

8. The method according to claim 7, wherein the azimuthal structure is impressed in the annular gap.

9. The method according to claim 1, wherein the liquid is discharged into the atomizer device chamber into a gaseous environment, a liquid environment or an environment of reduced pressure.

10. The method according to claim 1, wherein different liquids are discharged through several annular gaps into an environment and disintegrate into liquid droplets.

11. The method according to claim 1, wherein the at least one constriction on the at least one annular gap is at least 1% of a width of the at least one annular gap.

12. The method according to claim 1, wherein at least two constrictions are produced on the at least one annular gap.

13. An atomizer device adjusted for atomization of a liquid, comprising:
a concentric arrangement of at least two annular gap parts between which at least one annular gap is formed, and
a drive apparatus with which at least one circumferential constriction can be produced on the at least one annular gap.

14. The atomizer device according to claim 13, wherein the drive apparatus comprises an oscillation source with which a gap oscillation can be excited on at least one of the annular gap parts in such a manner that the constriction is running along on the at least one annular gap.

15. The atomizer device according to claim 14, wherein a first annular gap is provided that is limited by a first and a second annular gap part, and the oscillation source is provided for the exciting of the gap oscillation of at least one of the first and second annular gap parts.

16. The atomizer device according to claim 15, wherein a second annular gap is provided that is limited by the second annular gap part and a third annular gap part that surrounds the second annular gap part, and the oscillation source is provided for the exciting of the gap oscillation of second annular gap part.

17. The atomizer device according to claim 15, wherein the second annular gap part comprises a conduit in which the first annular gap part is arranged.

18. The atomizer device according to claim 17, wherein the first annular gap part comprises a cylindrical pin.

19. The atomizer device according to claim 18, wherein the first annular gap part is hollow.

20. The atomizer device according to claim 13, wherein at least one of the annular gap parts has a surface structure for the impressing of an azimuthal structure on at least one liquid surface of the liquid being let out through the at least one annular gap.

21. The atomizer device according to claim 13, wherein the at least one annular gap is circular, elliptical or polygonal.

22. The atomizer device according to claim 13, comprising a supply side provided for the supplying of the liquid to the at least one annular gap.

23. The atomizer device according to claim 22, wherein the supply side is connected to a liquid reservoir.

24. The atomizer device according to claim 23, wherein a pump apparatus is provided with which the liquid can be supplied under pressure into the at least one annular gap.

25. The atomizer device according to claim 13, that comprises an outlet side provided for discharging the liquid from the atomizer device, and at which the at least one annular gap empties into an environment of the atomizer device.

26. The atomizer device according to claim 25, wherein the outlet side is connected to an atomizer device chamber.

27. The atomizer device according to claim 26, wherein the atomizer device chamber is filled with a gas or a liquid or is loaded with a vacuum.

28. Method of using a device according to claim 13, comprising the step of:
supplying fuel into a combustion chamber,
forming active-substance aerosols, or
producing snow crystals.
